(19) United States
(12) Patent Application Publication
(10) Pub. No.: US 2022/0249218 A1
(43) Pub. Date: Aug. 11, 2022

(54) FOOLPROOF PERIODONTAL SULCUS BRUSH AND INTRASULCULAR MEDICAMENT APPLICATOR AND METHOD OF USE

(71) Applicant: Salvatore DeRicco, West Harrison, NY (US)

(72) Inventor: Salvatore DeRicco, West Harrison, NY (US)

(21) Appl. No.: 17/715,024

(22) Filed: Apr. 6, 2022

Related U.S. Application Data
(60) Provisional application No. 63/146,578, filed on Feb. 6, 2021.

(51) Int. Cl. A61C 19/06; A46B 5/00; A46B 9/02; A46B 9/04; A61C 17/22; A61C 17/34

(52) U.S. Cl. CPC A61C 19/063; A46B 5/00; A46B 9/026; A46B 2200/1093; A61C 17/225; A61C 17/349; A46B 2200/108; A46B 9/04

(57) ABSTRACT

According to an exemplary embodiment, a foolproof periodontal sulcus brush and intrasulcular medicament applicator, having one or two heads, for use in a variety of humans and animals, and its method of use, may be shown and described. The foolproof periodontal sulcus brush and intrasulcular medicament applicator can have offset heads and bristle areas, and include multiple curves of a neck portion—to provide improved access and cleaning ability, and may be separable or combined with toothbrush and/or other oral care brush elements or components, including a motorized or manual handle.

### CROSS-REFERENCE TO RELATED APPLICATIONS

This application claims priority from U.S. Provisional Patent Applications No. 63/146,578 filed on Feb. 6, 2021 and entitled “FOOLPROOF PERIODONTAL SULCUS BRUSH AND INTRASULCULAR MEDICAMENT APPLICATOR AND METHOD OF USE”, the contents of which are hereby incorporated, by reference.

### BACKGROUND

A very important aspect of oral hygiene—in both humans and animals—namely domesticated animals and pets, is the proper care of the gingival tissues (gums). The gum line and the gingival sulcus—the crevice between the gums and teeth—which begins at the gum line, are critical anatomical structures associated with not only oral health, but also overall health—since, in poor health, they are highly correlated with many serious illnesses, including numerous life-threatening ones, the likes of heart disease, kidney, liver, and lung disease, diabetes, and tumors, amongst others—in humans and pets; and Alzheimer's Disease, and more severe effects of COVID-19 infection—in humans. Domesticated animals and pets routinely suffer from various oral hygiene issues, due to genetics, diet, living conditions, or any combination of the three. Cats and dogs are typically treated by a veterinarian for various oral hygiene issues, but owners typically have little tendency to assist with oral hygiene issues.

Dental implants have been widely used in the replacement of hopeless and missing natural teeth, for decades, and are becoming increasingly utilized, as they continue to evolve and improve. But just like natural teeth, dental implants must be well-maintained—for good oral health, and their success and longevity. The American Academy of Periodontology recently released the proceedings from the World Workshop on the Classification of Periodontal and Peri-implant Diseases and Conditions—which, for the first time ever, included classifications for peri-implant conditions, thereby formalizing such maladies.

The gingival sulcus—around natural teeth, and the peri-implant crevice—around dental implants—are 360 degree/circumferential “potential spaces” which lie in between natural teeth and their surrounding gingiva and in between dental implants and their surrounding gingiva—much like the relationship between a turtle-neck shirt collar and one's neck, with the exception that they attach to the tooth/implant—at their bases. Pathogenic bacteria from microbe-laden dental plaque can result in the development of mild inflammatory periodontal disease—at the gum lines surrounding natural teeth and implant-supported artificial teeth, which can then progress down into these potential spaces, and result in the development of more advanced inflammatory periodontal disease. Natural teeth are susceptible to developing gingivitis—which can then progress to periodontitis—resulting in the loss of supporting bone and gum tissue/gingiva, which surrounds the teeth and, eventually, loss of the teeth, themselves. Similarly, dental implants are susceptible to peri-implant mucositis and peri-implantitis—which are tantamount to gingivitis and periodontitis—around natural teeth, and which can result in the loss of dental implants. As such, it behooves us to practice thorough and effective daily oral hygiene—to remove these pathogens, daily, and to prevent them—first, from remaining at our gum lines, and later, from invading the gingival sulci and peri-implant crevices; both of which result in the aforementioned progressive, inflammatory disease processes.

Ideal health of the sulci around individual natural teeth and the peri-implant crevices around individual implants are a challenge to maintain—especially on the lingual aspects of maxillary (upper) and mandibular (lower) teeth and implants, since the maxillary and mandibular anterior (front) teeth and the tongue obstruct access to their being cleansed. And, to further complicate oral hygiene considerations, when missing teeth are replaced by multi-tooth fixed prostheses—whether natural tooth-borne or implant-supported, they make toothbrush and other oral care brush access to the abutment (anchoring) teeth's sulci or to the implants' peri-implant crevices even more difficult and, potentially, impossible. Finally, the fixed prostheses, themselves, accumulate dental plaque and should also be thoroughly cleansed, on a daily basis. These prostheses may simulate the proportions of the crowns of the natural teeth they've replaced, or—due to the loss of some of the bone and gingiva which supported and surrounded the previously-existing natural teeth, they may be also be restoring the proportions of some degree of the roots of those teeth, and/or of the lost gingiva—thereby resulting in prostheses which have significantly greater height, and bucco-lingual (cheek-to-tongue) width, than just that of the crowns of the natural teeth they've replaced.

Currently available toothbrushes and other oral care brushes are poorly suited as foolproof periodontal sulcus brushes and intrasulcular medicament applicators, by design, including those which are labeled “sulcus brushes” or “implant brushes” and/or marketed for sulcular brushing. They are typically designed for humans brushing the chewing, labial, and buccal surfaces of their own teeth. Current toothbrushes and other oral care brushes are also poorly suited to fit under (for mandibular teeth) and above (for maxillary teeth) multi-tooth fixed prostheses—to cleanse between the prostheses and gingiva, as well as between the prostheses and/or their supporting abutment teeth and/or supporting implants and in-between multiple supporting implants, as well. In the most extensive restorative cases, a full-arch restoration—replacing all teeth in a dental arch—is supported by and affixed to multiple dental implants; these restorations and implants typically present the greatest challenges regarding plaque removal.

Despite numerous toothbrush and other oral care brush designs having been proposed to improve periodontal/sulcular brushing, no prior art toothbrush or other oral care brush is presently known, which combines a single row of bristles—for unimpeded and predictable sulcular penetration, and an offset head—to overcome the physical obstruction by the teeth, themselves, in accessing the sulci—from the proper angle, determined by Charles C. Bass, M.D., in 1954, to be 45-degrees—on the lingual/palatal aspects of the teeth—for both humans and pets; or to reach under fixed prostheses—from both labial and lingual approaches, and to cleanse the prostheses, themselves, as well as in-between and around their supporting natural teeth and/or dental implants; or to access the regions of teeth with lingual orthodontic braces, which lie between the braces and gingival margin. Accordingly, it is desirable to provide a foolproof periodontal sulcus brush and intrasulcular medicament applicator, to predictably enable the cleansing of gingival margins and sulci, peri-implant crevices, and fixed prostheses, as well as to deliver medicaments to the sulci, which can overcome the limitations of presently-available toothbrushes and other oral care brushes. Humans and domesticated pets, alike, benefit from this foolproof periodontal sulcus brush and intrasulcular medicament applicator design; therefore, it is an objective of this invention to provide a foolproof periodontal sulcus brush and intrasulcular medicament applicator and a method to enable, facilitate, and simplify the brushing of the aforementioned structures, and the application of medicaments—for the daily maintenance of good gingival, periodontal, oral, and systemic health.

### SUMMARY

According to an exemplary embodiment, a foolproof periodontal sulcus brush and intrasulcular medicament applicator, having one or two heads, for use in a variety of humans and animals, and its method of use, may be shown and described. The foolproof periodontal sulcus brush and intrasulcular medicament applicator can have offset heads and bristle areas, and include multiple curves of a neck portion—to provide improved access and cleaning ability, and may be separable or combined with toothbrush and/or other oral care brush elements or components, including a motorized or manual handle.

### BRIEF DESCRIPTION OF THE FIGURES

Advantages of embodiments of the present invention will be apparent from the following detailed description of the exemplary embodiments. The following detailed description should be considered in conjunction with the accompanying figures in which:

FIG. 1 is a front perspective view of a double-headed foolproof periodontal sulcus brush and intrasulcular medicament applicator.

FIG. 2 is a front elevation view, thereof

FIG. 3 is a front elevation view, thereof

FIG. 4 is a left-side elevation view, thereof

FIG. 5 is a right-side elevation view, thereof

FIG. 6 is a top plan view, thereof

FIG. 7 an exemplary image of a foolproof periodontal sulcus brush and intrasulcular medicament applicator in use

FIG. 8 is an exemplary image of a foolproof periodontal sulcus brush and intrasulcular medicament applicator in use

FIG. 9 is a top plan view of a foolproof periodontal sulcus brush and intrasulcular medicament applicator

FIG. 10 is an exemplary image of a foolproof periodontal sulcus brush and intrasulcular medicament applicator in use

FIG. 11 is an exemplary image of a foolproof periodontal sulcus brush and intrasulcular medicament applicator in use

FIG. 12 is a front perspective view of a single-headed foolproof periodontal sulcus brush and intrasulcular medicament applicator

FIG. 13 is a left-side elevation view, thereof

FIG. 14 is a bottom plan view, thereof

FIG. 15 is an exemplary image of a foolproof periodontal sulcus brush and intrasulcular medicament applicator in use

FIG. 16 is an exemplary image of a foolproof periodontal sulcus brush and intrasulcular medicament applicator in use

FIG. 17 is a front perspective view of a foolproof periodontal sulcus brush and intrasulcular medicament applicator removable head

FIG. 18 is a front perspective view of a single-headed, multi-row, foolproof periodontal sulcus brush and intrasulcular medicament applicator

FIG. 19 is a left-side elevation view, thereof

FIG. 20 is a bottom plan view, thereof

FIG. 21 is an exemplary image of a single-headed, multi-row, foolproof periodontal sulcus brush and intrasulcular medicament applicator in use

FIG. 22 is an exemplary image of a single-headed, multi-row, foolproof periodontal sulcus brush and intrasulcular medicament applicator in use

FIG. 23 is a front perspective view of a multi-row, foolproof periodontal sulcus brush and intrasulcular medicament applicator removable head

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description, discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

Generally referring to the figures, a method, system and apparatus for a foolproof periodontal sulcus brush and intrasulcular medicament applicator may be shown and described. The foolproof periodontal sulcus brush and intrasulcular medicament applicator can be formed in a variety of designs and utilize various combinations of handles, necks, heads, and bristles—to provide desired oral hygiene and/or intrasulcular medicament application functions. Also, all heads could be releasably attached and have couplings for mating to a motorized or manual handle.

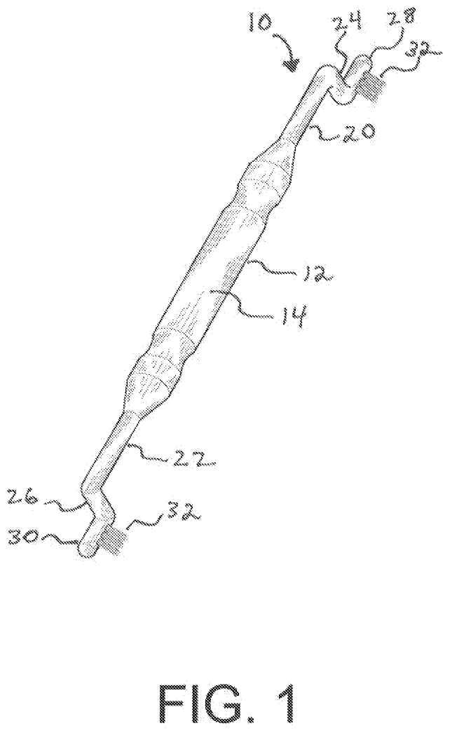

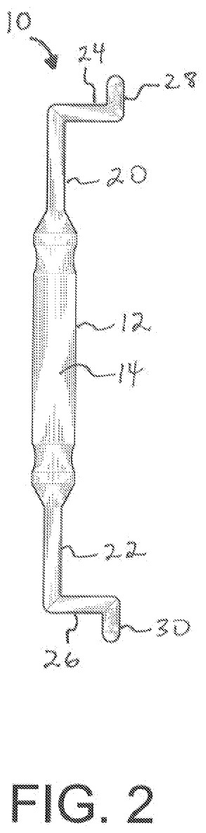

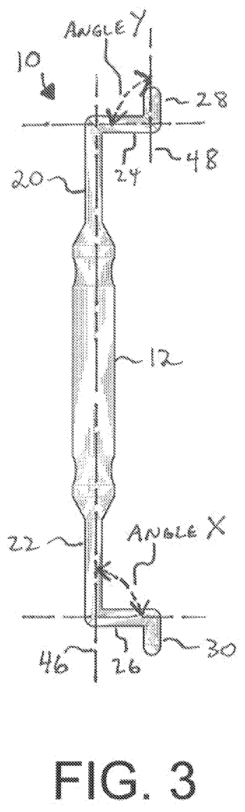

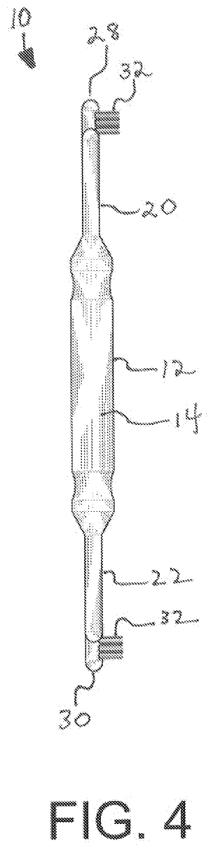

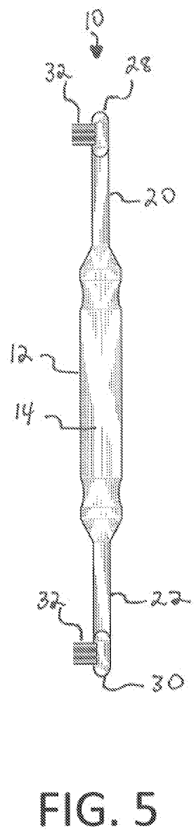

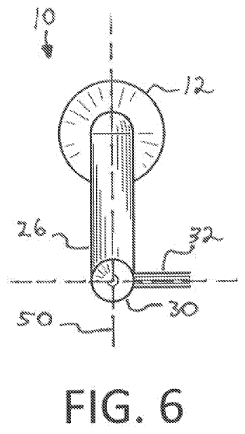

Referring now to FIGS. 1-6, a double-headed foolproof periodontal sulcus brush and intrasulcular medicament applicator 10 may be shown. The brush/applicator 10 may be formed out of any of a variety of materials, including, but not limited to, plastics, composites, or any other desired material. The foolproof periodontal sulcus brush and intrasulcular medicament applicator 10 can have a handle 12 formed as a body and a gripping portion 14, neck portions 20, 22, 24, 26, and head portions 28, 30. A central body or handle 12 of the double-headed foolproof periodontal sulcus brush and intrasulcular medicament applicator 10 may be substantially flat, square, rectangular, cylindrical, or any combination thereof. Further, the heads 28, 30 and necks 20, 22, 24, 26 may be formed in any shape. For example, the heads 28, 30 and necks 20, 22, 24, 26 may have cylindrical, circular, or rounded shapes, to provide for comfort in use in a mouth. The neck 20, 22, 24, 26 and/or head 28, 30 portions may be substantially curved, as desired, and as shown in exemplary FIGS. 1, 2, and 3. Further, the heads 28, 30 may include a plurality of bristle tufts 32. The bristle tufts 32 may be utilized in any number, for example three bristle tufts, and may be spaced apart substantially equidistantly. It may further be appreciated that the number of bristles tufts may be from one to ten tufts, as desired and depending, for example, on which species and oral region the foolproof periodontal sulcus brush and intrasulcular medicament applicator is being used. The spacing may be about 0.5 mm to about 4 mm, for example. The bristles 32 may have any length, for example about 5 mm to about 10 mm or more, as desired. Total length of the heads 28, 30 of the foolproof periodontal sulcus brush and intrasulcular medicament applicator 10 may be about 6 mm to about 30 mm or more, as desired. Further, the two heads of the double-headed foolproof periodontal sulcus brush and intrasulcular medicament applicator 10 may be releasably coupled to each other or a handle, permanently affixed to each other or a handle or otherwise coupled. For example, a first head on a double-headed foolproof periodontal sulcus brush and intrasulcular medicament applicator 10 may be swapped out for a different head having a different neck angle or combination of neck angles. Such applications may be beneficial for use or treatment with different types of jaw structures or animals, replacing brush/applicator heads due to wear, or providing varied treatment to an intended user or animal. Additionally, one or both heads could be releasably attached and have couplings for mating one or both brush/applicator heads to a motorized or manual handle.

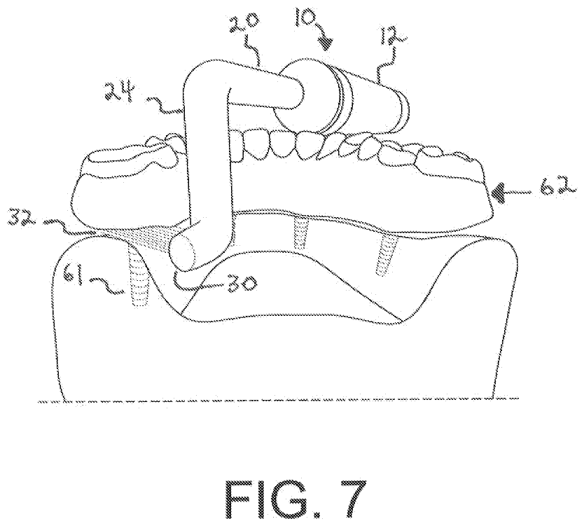

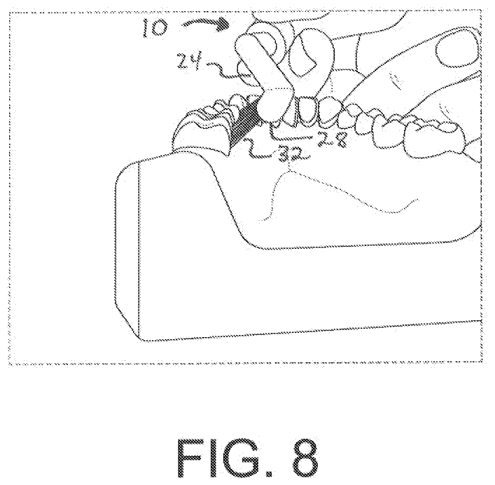

Still referring to exemplary FIGS. 1-6, on both ends of the foolproof periodontal sulcus brush and intrasulcular medicament applicator 10 handle 12, there are necks 20, 22, 24, 26 which connect, respectively, to the brush/applicator heads 28, 30. The proximal 20, 22 necks both extend away—in opposite directions, from the handle 12, along its longitudinal axis 46, and thus laterally offset the brush/applicator heads 28, 30 from the handle 12. In addition, each brush/applicator head 28, 30 may have a distal neck 24, 26 that allows for one or both heads 28, 30 to be vertically-offset, from the handle 12, by virtue of multiple bends. Each distal neck 24, 26 of the foolproof periodontal sulcus brush and intrasulcular medicament applicator 10 may have a departure angle—Angle X, from the longitudinal axis 46 of the handle 12 and proximal neck 20, 22 of about 75 degrees to about 105 degrees, for example about 90 degrees and may then have a second bend, with a departure angle Angle Y, into the into the longitudinal axis 48 of the head 28, 30 of the foolproof periodontal sulcus brush and intrasulcular medicament applicator 10, of about 75 degrees to about 105 degrees, for example about 90 degrees, to provide for enhanced utility in navigating the mouth of an intended user or animal. Each head 28, 30 may have a plurality of bristle tufts 32 projecting from it; the bristle tufts 32 are most ideally oriented in a single row, and they may be oriented perpendicular to the plane 50 of the distal necks 24, 26 and handle 12. This can be further illustrated in exemplary FIGS. 7-8, showing foolproof periodontal sulcus brush and intrasulcular medicament applicators 10, in use. As demonstrated in these figures, the handle 12, head 28, 30, neck 20, 22, 24, 26, and bristle 32 orientations allow for the cleaning of gingiva, teeth, implants, and prostheses and the application of medicaments, in varying dental scenarios, that could not have previously been cleaned or had medicaments applied, without significant irritation from, or general ineffectiveness of, currently available toothbrushes or other oral care brushes. The offset heads 28, 30 permit the bristles 32 to effectively reach the lingual sulci of the posterior teeth, without the handle 12 contacting the anterior teeth, and inhibiting such access, as is typical of other known oral care brush designs, especially those without offset heads. This configuration also permits the bristles 32 to fit underneath a prosthesis 62. As shown in these exemplary figures, such head and neck designs can allow for the cleaning of gingiva, teeth, implants, and/or prostheses that were previously inaccessible or otherwise positioned in such a manner that known toothbrushes and other oral care brushes could not access them properly, for cleaning, or for the application of intrasulcular medicaments.

Referring further to FIGS. 1-6, there is shown an exemplary embodiment of a double-ended foolproof periodontal sulcus brush and intrasulcular medicament applicator 10. FIGS. 1-5 show a foolproof periodontal sulcus brush and intrasulcular medicament applicator 10 having a handle 12 and brush heads 28, 30 attached to both ends of the handle 12. More specifically, the handle 12 includes a gripping portion 14 that is substantially linear and defined by a longitudinal axis 46. In a preferred embodiment, the handle 12 and gripping portion 14 have a planar shape with a circular cross section. The circular cross section of the handle 12 provides an ergonomic design for gripping and maneuvering the foolproof periodontal sulcus brush and intrasulcular medicament applicator 10 during a brushing session. In addition, the circular cross section provides a means for an individual with a fixed prosthesis to grip the toothbrush so that bristles 32 may be freely oriented, relative to fitting under a prosthesis, (see FIG. 7), as well as also being able to fit under the gum line, and into the gingival sulcus and/or peri-implant crevice—at an entirely different angle, (see FIG. 8), in order to yield optimal cleaning and efficiency. Although it is preferred that the handle 12 and gripping portion 14 have a circular cross section—to permit all angulations for access to the intended anatomical and prosthetic targets, other cross-sectional shapes can be used. For example, the handle 12 and gripping portion 14 may have a planar shape with a rectangular cross section. In another embodiment, the handle 12 and gripping portion 14 may comprise a planar shape with a square cross section. Each cross sectional design—circular, rectangular, or square—of the handle 12 contributes to how the foolproof periodontal sulcus brush and intrasulcular medicament applicator 10 is held, and has its own advantages in facilitating optimal cleaning of the teeth, implants, gingival sulci, peri-implant crevices, and prostheses. Moreover, each design provides a left or right handed individual means to comfortably grip and control the foolproof periodontal sulcus brush and intrasulcular medicament applicator 10.

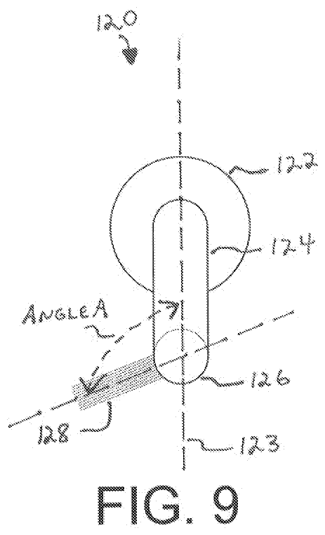

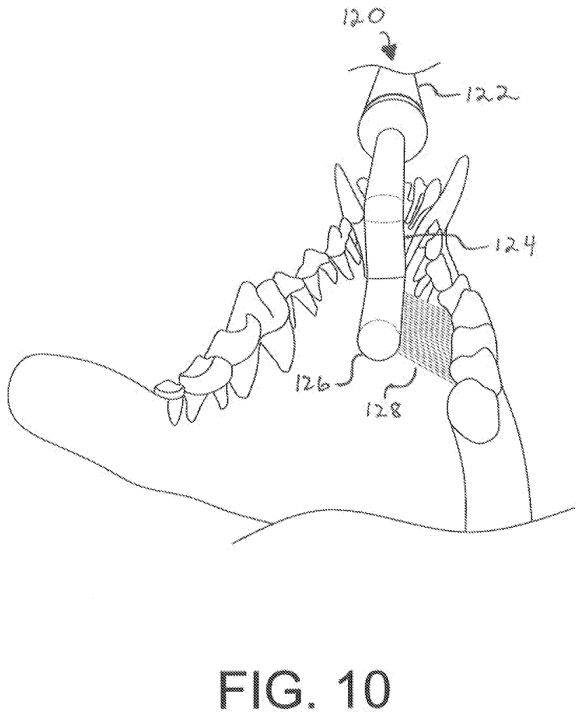

In a further exemplary embodiment, and referring now to exemplary FIG. 9, it may be appreciated that the foolproof periodontal sulcus brush and intrasulcular medicament applicator 120 may have varying neck 124 lengths—for varying degrees of vertical offset of the head 126, to conform to varying oral hygiene and medicament application objectives. The bristles 128 may also be oriented obliquely—Angle A, to the plane 123 of the handle 122 and distal neck 124 and head 126, especially if that may facilitate entry into the gingival sulcus at the recommended 45 degree angle to the labial and lingual surfaces of the teeth, at the gum line—for a human or for a caretaker of a human or other species, and/or for a particular region of the mouth. These can be varied, as desired, according to the exemplary embodiments described herein. This can be further illustrated in exemplary FIG. 10, showing a foolproof periodontal sulcus brush and intrasulcular medicament applicator 120, in use.

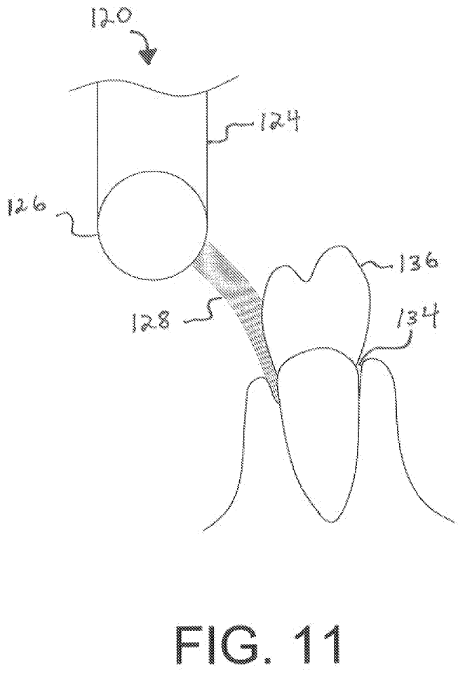

Referring now to FIG. 11, it is an exemplary image of a foolproof periodontal sulcus brush and intrasulcular medicament applicator 120 in use—with its bristles 128 penetrating into the gingival sulcus 134,—beginning at an approximate 45-degree angle to the surface of the tooth 136, for entry.

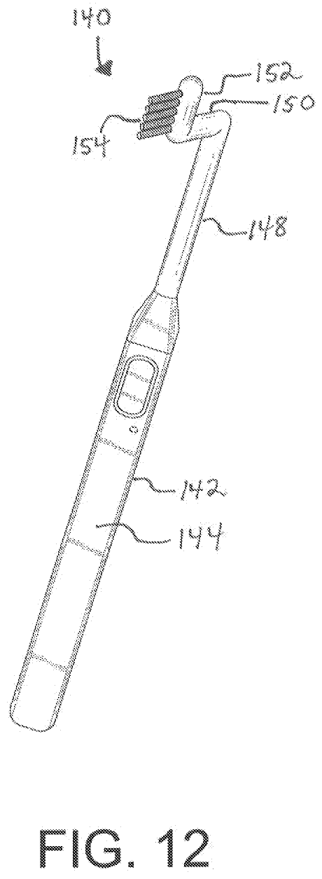

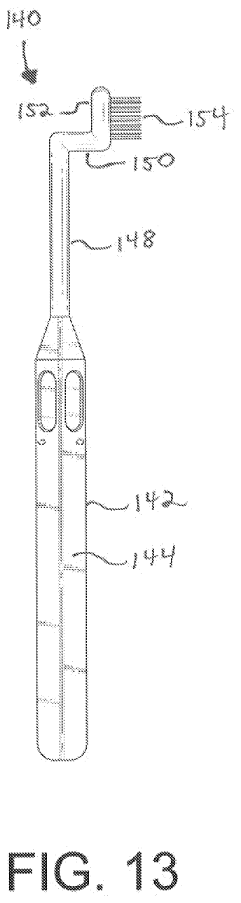

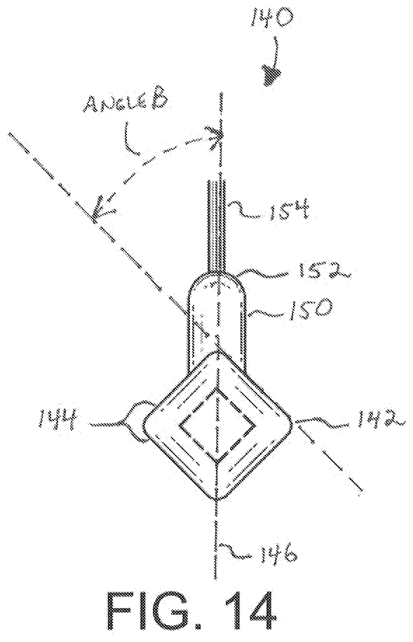

Referring now to FIGS. 12-14, a single-headed foolproof periodontal sulcus brush and intrasulcular medicament applicator 140 may be shown. The brush/applicator may be formed out of any of a variety of materials, including, but not limited to, plastics, composites, or any other desired material. The foolproof periodontal sulcus brush and intrasulcular medicament applicator 140 can have a handle 142 with a gripping portion 144, neck portions 148, 150, and a head portion 152. The handle 142 of the single-headed foolproof periodontal sulcus brush and intrasulcular medicament applicator may be substantially flat, square, rectangular, cylindrical, or any combination thereof, and may be solid or hollow. Further, the head 152 and necks 148, 150 may be formed in any shape. For example, the head 152 and necks 148, 150 may have cylindrical, circular, or rounded shapes, to provide for comfort in use in a mouth. The neck 148, 150 portions may be substantially curved, as desired, and as shown in exemplary FIGS. 12-13. And the neck 148, 150 portions may offset the head 152 forward of the handle 142, to improve access to the gingival sulci, which are obstructed from being properly accessed and entered, by currently available toothbrushes and other oral care brushes. Further, the head may include a plurality of bristle tufts 154. The bristle tufts may be utilized in any number, for example five bristle tufts or three bristle tufts, and may be spaced apart substantially equidistantly. It may further be appreciated that the number of bristles tufts may be from one to ten tufts, as desired and depending, for example, on which species and oral region the foolproof periodontal sulcus brush and intrasulcular medicament applicator 140 is being used. The spacing may be about 0.5 mm to about 4 mm, for example. The bristles 154 may have any length, for example about 5 mm to about 10 mm or more, as desired. Total length of the head 152 of the foolproof periodontal sulcus brush and intrasulcular medicament applicator 140 may be about 6 mm to about 30 mm or more, as desired. Referring now to FIG. 14, it is an exemplary image of a single-headed, square cross-sectional-handled, foolproof periodontal sulcus brush and intrasulcular medicament applicator 140, with the plane 146 of its bristles oriented/offset at a 45-degree angle—Angle B, to the sides of the handle, to facilitate achieving the 45-degree recommended angle—for gingival sulcus entry, when the handle is held with two sides paralleling the horizon. Further, the head 152 of the single-headed, foolproof periodontal sulcus brush and intrasulcular medicament applicator 140 may be releasably coupled to a motorized or other handle, permanently affixed to a motorized or manual handle, coupled to a toothbrush or another oral care brush, or otherwise coupled. Such applications may be beneficial for use or treatment with different types of jaw structures or animals, replacing brush/applicator heads due to wear, or providing varied treatment to an intended user or animal.

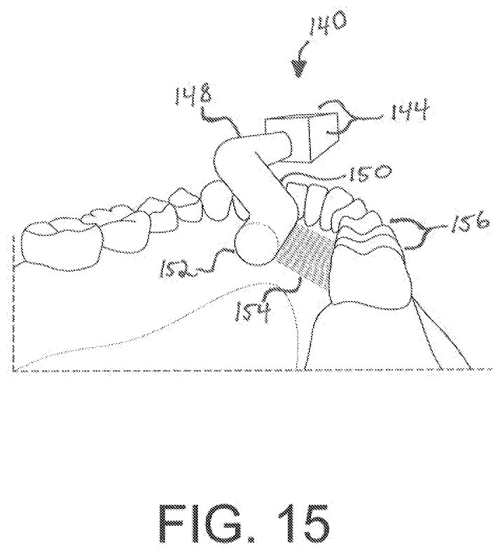

Referring now to FIG. 15, it is an exemplary image of a single-headed, square cross-sectional-handled, foolproof periodontal sulcus brush and intrasulcular medicament applicator 140 in use, with its bristles 154 oriented at a 45-degree angle to the lingual surfaces of the teeth 156, when the handle is held with two sides paralleling the plane of the chewing surfaces of the teeth 156, and the other two sides being perpendicular to that plane.

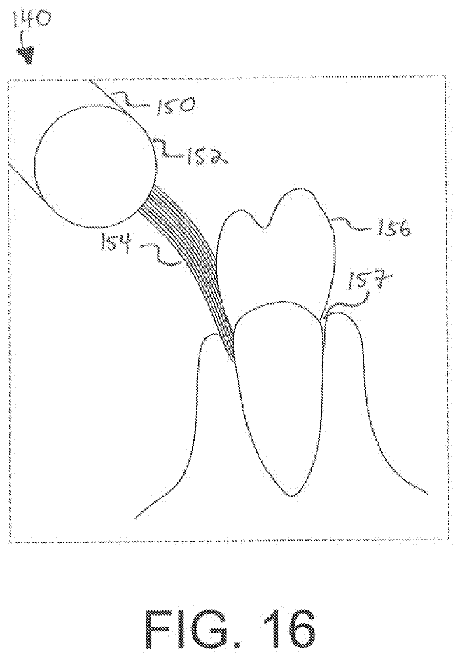

Referring now to FIG. 16, it is an exemplary image of a foolproof periodontal sulcus brush and intrasulcular medicament applicator 140 in use—with its bristles 154 penetrating into the gingival sulcus 157, after glancing off the tooth 156 at an approximately 45-degree angle, in order to guide their entry into the gingival sulcus.

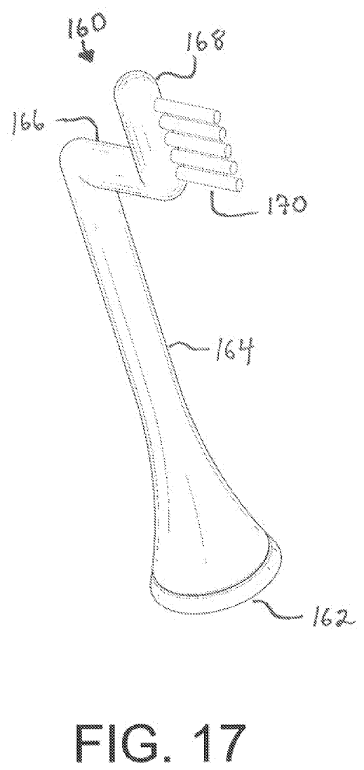

Referring now to FIG. 17, a foolproof periodontal sulcus brush and intrasulcular medicament applicator removable head 160 may be shown, which may be coupled to a motorized or manual handle. It is comprised of a base/connector 162, a proximal neck 164, a distal neck 166, and a head 168, with a plurality of bristles 170. The neck 164, 166 portions may offset the head 168 forward of the motorized handle (not depicted), to improve access to the gingival sulci, which are obstructed from being properly accessed and entered, by currently available toothbrushes and other oral care brushes. The head 168 and bristle 170 options are the same as for the foolproof periodontal sulcus brush and intrasulcular medicament applicator 140, previously described.

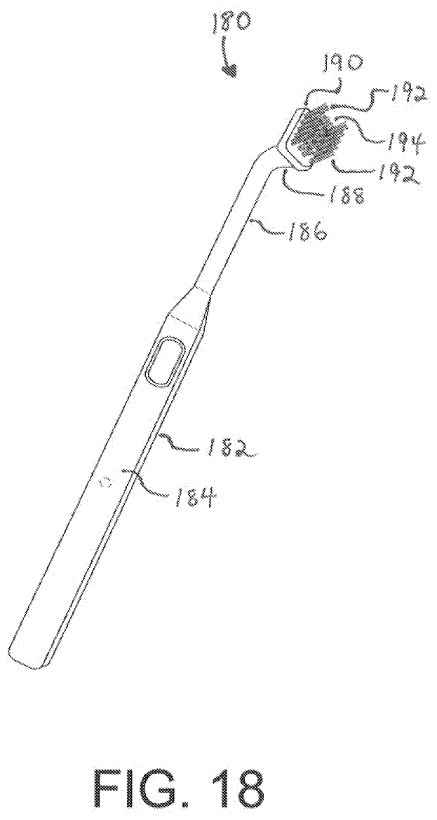

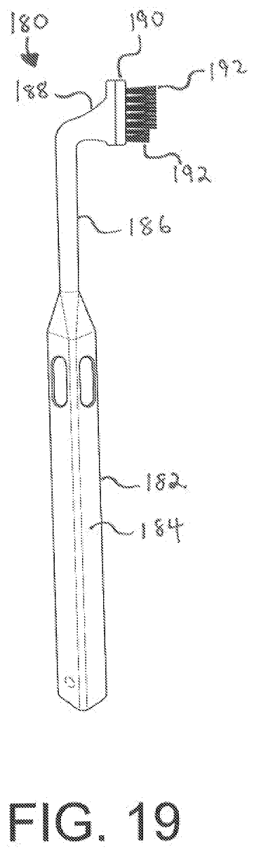

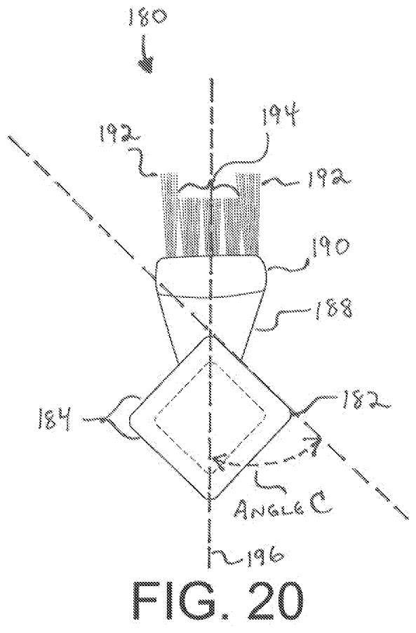

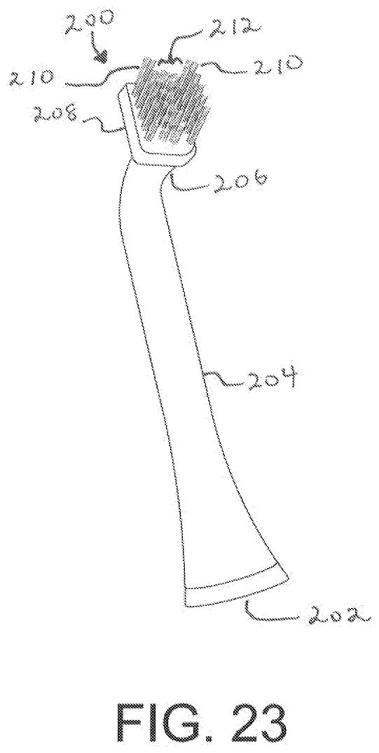

Referring now to FIGS. 23-25, a single-headed, multi-row, foolproof periodontal sulcus brush and intrasulcular medicament applicator 180 may be shown. The brush/applicator may be formed out of any of a variety of materials, including, but not limited to, plastics, composites, or any other desired material. The single-headed, multi-row foolproof periodontal sulcus brush and intrasulcular medicament applicator 180 can have a handle 182 with a gripping portion 184, neck portions 186, 188, and a head portion 190. The handle 182 of the single-headed, multi-row, foolproof periodontal sulcus brush and intrasulcular medicament applicator 180 may be substantially flat, square, rectangular, cylindrical, or any combination thereof, and may be solid or hollow. Further, the head 190 and necks 186, 188 may be formed in any shape. For example, the head 190 and necks 186, 188 may have a cylindrical, circular, or rounded shape so as to provide for comfort in use in a mouth. The neck portions 186, 188 may be substantially curved, as desired, and as shown in exemplary FIGS. 18 and 19. And the neck portions 186, 188 may offset the head 190 forward of the handle 182, to improve access to the gingival sulci which are obstructed from being properly accessed and entered, by currently available toothbrushes and other oral care brushes. Further, the head 190 may include a plurality of bristle tufts 192, 194, arranged in multiple vertical rows. The number of vertical rows may range from four to seven, or more. The number of bristle tufts 192, 194, in each vertical row, may be utilized in any number, for example five bristle tufts or three bristle tufts and may be spaced apart substantially equidistantly. It may further be appreciated that the number of bristles tufts in each vertical row, may be from one to ten tufts, as desired and depending, for example, on which species and oral region the single-headed, multi-row, foolproof periodontal sulcus brush and intrasulcular medicament applicator 180 is being used. The spacing may be about 0.5 mm to about 4 mm, for example. The bristles 192, 194 may have any length, for example about 4 mm to about 11 mm or more, as desired. And the length of the bristles 192 in the lateral rows of bristles 192 may be longer than the bristles 194 in the center rows of bristles 194, by 1.0-5.0 mm, or more, in order for the lateral rows of bristles 192 to penetrate the gingival sulci, without interference from, or impedance by, the center rows of bristles 194, and so that the center rows of bristles 194 may brush the chewing surfaces of the teeth, without interference from, or impedance by, the lateral rows of bristles 192. Further, the firmness of the bristles of the central 192 and lateral 194 rows of bristles may vary from one another, due to enamel being the hardest substance, in the body, and gingival tissues being amongst the most delicate. Total length of the head 190 of the single-headed, multi-row, foolproof periodontal sulcus brush and intrasulcular medicament applicator 180 may be about 6 mm to about 30 mm or more, as desired. Referring now to FIG. 20, it is an exemplary image of a single-headed, multi-row, square cross-sectional-handled, foolproof periodontal sulcus brush and intrasulcular medicament applicator 180, with the plane 196 of its bristles 192, 194 oriented/offset at a 45-degree angle—Angle C, to the sides of the handle 182, to facilitate achieving the 45-degree recommended angle—for gingival sulcus entry, of the lateral rows of bristles 192, when the handle is held with two sides paralleling the horizon. Further, the head 190 of the single-headed, multi-row, foolproof periodontal sulcus brush and intrasulcular medicament applicator 180 may be releasably coupled to a motorized or manual handle, permanently affixed to a motorized or manual handle, coupled to a toothbrush or another oral care brush, or otherwise coupled. Such applications may be beneficial for use or treatment with different types of jaw structures or animals, replacing brush/applicator heads due to wear, or providing varied treatment to an intended user or animal.

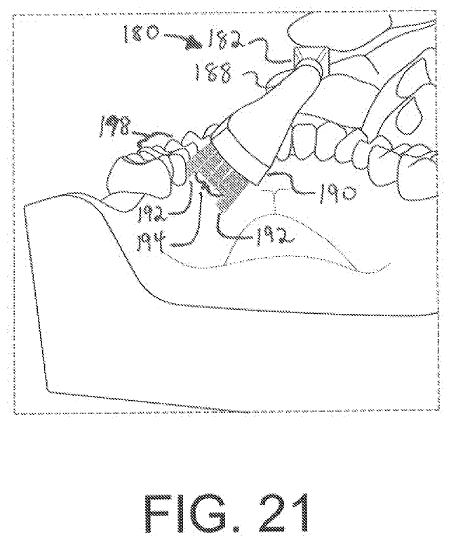

Referring now to FIG. 21, it is an exemplary image of a single-headed, multi-row, square cross-sectional-handled, foolproof periodontal sulcus brush and intrasulcular medicament applicator 180 in use, with one of its lateral rows of bristles 192 oriented at a 45-degree angle to the lingual surfaces of the teeth 198, when the handle 182 is held with two sides paralleling the plane of the chewing surfaces of the teeth 198, and the other two sides being perpendicular to that plane.

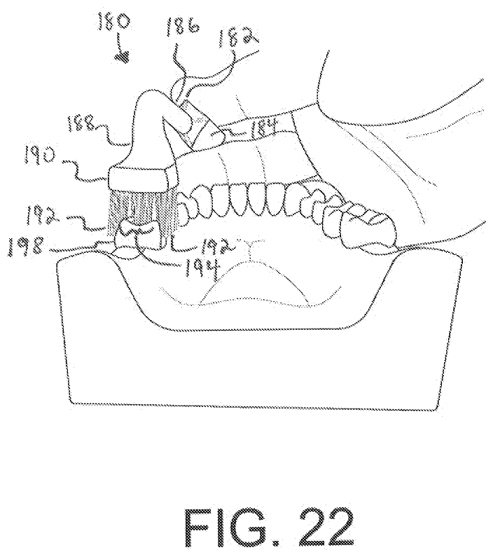

Referring now to FIG. 22, it is an exemplary image of a single-headed, multi-row, square cross-sectional-handled, foolproof periodontal sulcus brush and intrasulcular medicament applicator 180 in use, with its bristles 192, 194 oriented perpendicular to the plane of the chewing surfaces of the teeth 198, and with the lateral rows of bristles 192 straddling the buccal and lingual surfaces of the teeth 198, to prevent interference, with the brushing of the chewing surfaces.

Referring now to FIG. 23, a multi-row, foolproof periodontal sulcus brush and intrasulcular medicament applicator removable head 200 may be shown, which may be coupled to a motorized or manual handle. It is comprised of a base/connector 202, a proximal neck 204, a distal neck 206, and a head 208, with a plurality of bristles 210, 212. The neck 164, 166 portions may offset the head 168 forward of the motorized handle (not depicted), to improve access to the gingival sulci, which are obstructed from being properly accessed and entered, by currently available toothbrushes and other oral care brushes. The head 208 and bristle 210, 212 options are the same as for the single-headed, multi-row, foolproof periodontal sulcus brush and intrasulcular medicament applicator 180, previously described.

The foregoing description and accompanying figures illustrate the principles, preferred embodiments, and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art, without departing from the scope of the invention, as defined by the following claims.

What is claimed is:

1. A foolproof periodontal sulcus brush and intrasulcular medicament applicator for cleaning gums, teeth, dental implants and fixed prostheses, and for delivering medicaments to gingival sulci and peri-implant crevices, comprising:
a handle having a gripping section;
a curved neck, with proximal and distal portions, attached to one end of the handle, said end of the handle tapering towards said neck, said neck having a cylindrical shape and substantially circular cross section, the proximal neck portion extending outward from the handle in a direction collinear with a longitudinal axis of the handle and then curving into a distal neck portion;
a brush head attached to the distal neck portion, said brush head having a substantially circular cross section and a substantially dome-shaped end, said brush head being coplanar with the longitudinal plane of the handle and neck and having a longitudinal axis parallel to the longitudinal axis of the handle; and
at least one bristle tuft extending from said brush head, said at least one bristle tuft is oriented perpendicular relative to the longitudinal axis of the brush head, and coplanar with the handle, neck, and brush head; and
said at least one bristle tuft comprising a plurality of bristles, said bristles having a length 5 to 10 mm or longer and extending from said brush head in a common direction and parallel with each other.

2. The foolproof periodontal sulcus brush and intrasulcular medicament applicator of claim 1, wherein said handle has a square cross section, and said bristle tuft is oriented at 45 degrees, relative to two surfaces of the handle that form the square cross section and at 135 degrees, relative to the other two surfaces of the handle that form the square cross section.

3. The foolproof periodontal sulcus brush and intrasulcular medicament applicator of claim 1, wherein said handle has a circular cross section and curved surfaces.

4. The foolproof periodontal sulcus brush and intrasulcular medicament applicator of claim 1, wherein said at least one bristle tuft comprises three or more bristle tufts disposed in a single row.

5. The foolproof periodontal sulcus brush and intrasulcular medicament applicator of claim 1, wherein said neck comprises a proximal neck and a distal neck, wherein said distal neck is coplanar with the proximal neck and handle and extends away from the longitudinal axis of said handle and proximal neck at an angle between 75 degrees and 105 degrees.

6. The foolproof periodontal sulcus brush and intrasulcular medicament applicator of claim 1, wherein the neck and brush head may be configured to releasably attach to a manual or motorized handle.

7. A foolproof periodontal sulcus brush and intrasulcular medicament applicator for cleaning gums, teeth, dental implants and fixed prostheses, comprising:
a handle having a gripping section with two ends;
a curved neck, with proximal and distal portions, attached to each end of the handle, said ends of the handle tapering towards said necks, said necks having a cylindrical shape and substantially circular cross section, each proximal neck portion extending outward from the handle in a direction collinear with a longitudinal axis of the handle and then curving into a distal neck portion;
a brush head attached to each distal neck portion, said brush heads having a substantially circular cross section and a substantially dome-shaped end, said brush heads being coplanar with the longitudinal plane of the handle and necks and having a longitudinal axis parallel to the longitudinal axis of the handle; and at least one bristle tuft extending from each brush head, each said bristle tuft being oriented perpendicular to the longitudinal axis of each brush head, and relative to the longitudinal plane of the handle, necks and brush heads; and
said at least one bristle tuft comprising a plurality of bristles, said bristles having a length 5 to 10 mm or longer and extending from each brush head in a common direction and parallel with each other.

8. The foolproof periodontal sulcus brush and intrasulcular medicament applicator of claim 7, wherein each distal neck portion extends away from the longitudinal axis of said handle and proximal neck portion, at an angle between 75 degrees and 105 degrees.

9. The foolproof periodontal sulcus brush and intrasulcular medicament applicator of claim 7, wherein said at least one bristle tuft of each brush head comprises a plurality of bristle tufts, said bristle tufts are substantially parallel to each other.

10. The foolproof periodontal sulcus brush and intrasulcular medicament applicator of claim 7, wherein said at least one bristle tuft of each brush head is oriented relative to the longitudinal plane of said handle, necks, and heads at an angle between 45 degrees and 90 degrees.

11. The foolproof periodontal sulcus brush and intrasulcular medicament applicator of claim 7, wherein said at least one bristle tuft of each brush head comprises three or more bristle tufts all disposed in a single row aligned with the longitudinal axis of the brush head.

12. The foolproof periodontal sulcus brush and intrasulcular medicament applicator of claim 7, wherein each neck distal neck portion extends in the same direction and at the same angle away from the longitudinal axis of the handle and proximal neck portion.

13. The foolproof periodontal sulcus brush and intrasulcular medicament applicator of claim 7, wherein said handle comprises a rectangular cross section and is linear, and each brush head comprises a cylindrical shape with a circular cross section and a substantially dome-shaped end.

14. The foolproof periodontal sulcus brush and intrasulcular medicament applicator of claim 7, wherein said bristle tufts are oriented at an oblique angle, relative to the plane of the handle, necks, and brush heads.

15. The foolproof periodontal sulcus brush and intrasulcular medicament applicator of claim 7, wherein the necks and brush heads may be configured to releasably attach to a manual or motorized handle.

16. A foolproof periodontal sulcus brush and intrasulcular medicament applicator for cleaning gums, teeth, dental implants and fixed prostheses, and for delivering medicaments to gingival sulci and peri-implant crevices, comprising:
a handle having a gripping section;
a curved neck, with proximal and distal portions, attached to one end of the handle, said end of the handle tapering towards said neck, said neck having a cylindrical shape and substantially circular cross section, the proximal neck portion extending outward from the handle in a direction collinear with a longitudinal axis of the handle and then curving into a distal neck portion;
a brush head attached to the distal neck portion, said brush head having a substantially rectangular cross section, said brush head being perpendicular to the longitudinal plane of the handle and neck; and
at least one bristle tuft extending from said brush head, said at least one bristle tuft is oriented perpendicular relative to the plane of the brush head, and coplanar with the handle and neck; and
said at least one bristle tuft comprising a plurality of bristles, said bristles having a length 5 to 10 mm or longer and extending from said brush head in a common direction and parallel with each other.

17. The foolproof periodontal sulcus brush and intrasulcular medicament applicator of claim 16, wherein said handle has a square cross section, and said bristle tuft is oriented at 45 degrees, relative to two surfaces of the handle that form the square cross section and at 135 degrees, relative to the other two surfaces of the handle that form the square cross section.

18. The foolproof periodontal sulcus brush and intrasulcular medicament applicator of claim 16, wherein said at least one bristle tuft comprises three or more bristle tufts disposed in multiple rows, with the bristle lengths of the two lateral rows being at least 1.0 mm greater than the bristle lengths of the two or more central rows.

19. The foolproof periodontal sulcus brush and intrasulcular medicament applicator of claim 16, wherein said neck comprises a proximal neck and a distal neck, wherein said distal neck is coplanar with the proximal neck and handle and extends away from the longitudinal axis of said handle and proximal neck at an angle between 75 degrees and 105 degrees.

20. The foolproof periodontal sulcus brush and intrasulcular medicament applicator of claim 16, wherein the neck and brush head may be configured to releasably attach to a manual or motorized handle.
